(19) United States
(12) Patent Application Publication
(10) Pub. No.: US 2025/0229927 A1
(43) Pub. Date: Jul. 17, 2025

(54) A METHOD AND A DEVICE FOR MANUFACTURING A PORTION CAPSULE

(71) Applicant: Tchibo GmbH, Hamburg (DE)

(72) Inventor: Marius-Konstantin Wiche, Hamburg (DE)

(21) Appl. No.: 18/704,520

(22) PCT Filed: Oct. 21, 2022
(86) PCT No.: PCT/EP2022/079444

§ 371 Date: Apr. 25, 2024

(30) Foreign Application Priority Data
Oct. 27, 2021 (EP) 21205024.9

(51) Int. Cl. B65B 29/02; B65B 1/04; B65B 7/28; B65B 51/22; B65B 61/06

(52) U.S. Cl. CPC B65B 29/022; B65B 1/04; B65B 7/2842; B65B 51/225; B65B 61/065

(57) ABSTRACT

A method for manufacturing a portion capsule which is filled with an extraction material for the creation of a brewed product. The portion capsule includes a main body of plastic, the main body having a base region, a peripheral side wall, and a peripheral main body collar that connects to the peripheral side wall. After the main body is filled, a plastic lid is placed such that a lid collar lies on the main body collar, and the lid collar is fastened to the main body collar. An outer portion of the capsule collar is then separated away with a separating tool having a blade. The blade has a first region of a first material as well as a second region of a second material, wherein the first region forms the cutting edge and wherein the first material is harder than the second material.

### BACKGROUND OF THE INVENTION

### Field of the Invention

The invention relates to the preparation of drinks or the like from an extraction material, for example ground coffee, which is contained in a capsule. In particular, it relates to a portion capsule.

### Description of Related Art

Extraction apparatus for preparing drinks from an extraction material which is present in a portion package are known for example as coffee machines, espresso machines or also tea machines. In many corresponding systems, the portion packages are designed as capsules, in which the extraction material is closed off, for example in an airtight manner. For the extraction, the capsule is pierced at two sides which are opposite one another. Generally, hot water is introduced at the first side. The brewed product is led out of the capsule at the second side. Herein, quite a considerable pressure must prevail in the inside of the capsule, depending on the drink to be prepared.

In particular, aluminium and plastics, for example polypropylene have become known as capsule materials. However, aluminium capsules are very energy-intensive in their manufacture. Polypropylene capsules are advantageous concerning the energy expense and disposal, but place increased demands on the piercing mechanism and the preservation of the aroma. So called bio-plastics have also been discussed as capsule materials. On the one hand plastics, which are manufactured from a renewable raw material (so-called bio-based plastics), are denoted as bio-plastics. On the other hand, bio-plastics are plastics which are biologically degradable (so-called biodegradable plastics). The plastics which have been suggested for the manufacture of portion capsules are biodegradable and partly include a share of bio-based plastics. In the present text, “biodegradable” means biologically degradable according to the standard EN13432 (dated: end of 2020), and “bio-based” means “of renewable raw materials, not based on fossils”.

A coffee portion capsule which approximately has a cube shape and is manufactured of plastic is known from WO 2010/118543 and WO 2015/096990. In contrast to the known cup-shaped capsules, this includes a lid that is arched and not flat, and accordingly this capsule also no collar which is peripheral at the plane of the one (upper-side) cover surface. Such a collar according to the state of the art is necessary on closing by way of ultrasound welding, in order to accommodate an energy director. The capsule which is manufactured according to the teaching of WO 2010/18543), independently of its (“cube”) shape has a welding brow which is peripheral between the planes defined by the cover surface and which forms only a minimal collar and whose extension/lateral protrusion however is significantly reduced compared to collars of known capsules. For the manufacture, firstly a broad collar is created, along which one welds, whereupon an outer region of the collar is separated away.

Concerning plastic capsules according to WO 2010/118543 and WO 2015/096990 and also concerning other capsules with a relatively small collar, one must accordingly provide a working step in which the outer region of the collar is separated away. Conventional punching tools however have the problem that they wear relatively rapidly due to the plastic material being comparatively tough and the collar comparatively thick. In WO 2010/118543 and WO 2015/096990, the ultrasound separating welding method is also suggested for such separating-away. However, challenges concerning the complexity of the applied tools and their wearing also result with this.

### SUMMARY OF THE INVENTION

It is the object of the present invention to further develop a method for manufacturing capsules, for example of the type which is described in WO 2010/118543 and WO 2015/096990 such that the disadvantages of the state of the art are overcome and that in particular the manufacturing effort is reduced. A further object is to provide a corresponding device.

Concerning the method for manufacturing a portion capsule which is filled with extraction material for creating a brewed product, firstly a main body of a plastic, with a base region, with a peripheral side wall and with a peripheral main body collar which connects to the peripheral side wall is filled. A plastic lid (in particular of the same plastic as the main body) is subsequently placed such that a lid collar lies on the main body collar, and the lid collar is fastened to the plastic collar, for example by way of ultrasound welding. An outer portion of the thus arisen capsule collar is then separated away. Herein, the separating-away of the outer portion is effected amid the use of a separating tool with a blade having a cutting edge and being peripheral along the capsule collar. The applied blade includes a first region of a first material as well as a second region of a second material, wherein the first region extends up to the cutting edge and wherein the first material is harder than the second material.

The fact that the first region extends up to the cutting edge can mean that this in particular forms the cutting edge in the context that it extends up to the cutting edge at the very outermost, whereas at least after the first separation procedures the second region will be slightly set back compared to the first region, even if under certain circumstances this is only a microscopically small distance, depending on the thickness of the first region.

It has been found that the separating-away procedure can be rendered more efficient in this manner, since the blade of the separating tool needs to be exchanged less often. If material of the blade is worn away at the cutting edge, then a material removal in the second region is also effected in the direct vicinity of the cutting edge and specifically to a greater extent due to the smaller hardness, so that the actual cutting edge (at the very outermost) always consists of the first material. A self-sharpening effect results from this: the blade does not become as blunt as if it were to be worn away uniformly over its whole thickness. A self-sharpening effect has been conceived for knives of two differently hard materials by way of the knives also being simultaneously ground given their usage, for example by way of a movement relative to a cutting board. It has now been found that a self-sharpening effect can likewise be achieved with a circumferential blade, regarding which a conventional cutting movement is not possible.

For this purpose, the first region in particular is relatively thin (herein the thickness denotes the extension perpendicular to the direction of the relative movement of the separating tool and the counter-piece (for example separating sonotrode, see below) and perpendicular to the course of the cutting edge, i.e. the extension perpendicular to the blade surface). The thickness of the first region is for example not more than 40 μm, in particular not more than 30 μm, not more than 20 μm or not more than 10 μm.

For this reason, the first region can be a coating of the second region. Even if the first region has been produced in a fashion other than coating, the first and the second region extend along the blade plane up to the cutting edge or to close to this, for example up to at the most 1 mm or at the most 0.3 mm.

Methods for depositing the first region as a coating can include for example spray-coating, immersion and/or laser deposition (laser cladding; with an additive, in particular in powder form (pre-deposited or fed by powder feed), possibly also in wire form). Possible materials for a first region which is designed as a coating are diamond powder, diamond-like carbon (DLC), iron oxide, titanium oxide, ceramics, for example polycrystalline ceramics etc.

The procedure according to the invention is particularly favourable if the separating tool is designed as a separating anvil which includes the blade and supports the capsule collar during the separating-away. In particular, a sonotrode which vibrates during the separating-away procedure, in particular an ultrasound sonotrode serves as a counter-piece given the separating-away procedure. This sonotrode can include a plane coupling-out surface which given the separating procedure presses the capsule collar against the blade of the separating tool in a vibrating manner.

In particular, the separating anvil can be at rest during the separating procedure (the sonotrode is then moved downwards during the procedure) or at most can be subjected to a linear movement to the top towards the separating sonotrode. In any case, the separating anvil does not vibrate and given such embodiments the separating sonotrode as the counter-piece is that element which is active and also couples in the necessary energy-but despite this the described self-sharpening effect results.

The method can be carried out—and the device for its execution accordingly designed—such that one rules out the cutting edge and the counter-piece to the separating tool (in particular the counter-piece can be a separating sonotrode) never being able to contact completely. In these embodiments there are no particular demands on the hardness of the surface of the counter-piece which faces the cutting edge. This for example can be similar to the hardness of the second region; optionally the counter-piece can be manufactured of the same material as the second region. In other embodiments in which the cutting edge can contact the surface, one then envisages the surface which faces the cutting edge being even harder than the first region. The self-sharpening effect is accentuated by this measure and the service life, specifically also of the counter-piece, is positively influenced.

The fastening of the lid collar to the main body collar can be effected by way of ultrasound welding. Herein, one can utilise the same machine which generates the ultrasound, as for the subsequent separating procedure or another one. In both cases, in particular the anvil in which the capsule is supported and guided during the respective procedure can be a different one, i.e. the welding anvil then has no blade but a plane support surface.

With regard to the procedure of the welding, the welding sonotrode presses the lid collar in a vibrating manner against the main body collar which is supported by the welding anvil. The lid or the main body herein includes an energy director which can be designed for example as a peripheral fine rib. The welding sonotrode or the welding anvil can herein include a corresponding energy director rib, in particular if the lid or the main body has a more or less constant thickness, as is the case if it is manufactured by deep-drawing.

The shapes of the separating anvil, the counter-piece (in particular the separating sonotrode) and possibly the welding anvil and the welding sonotrode are matched to the capsule to be manufactured. In particular, in embodiments the cutting edge of the blade can form a closed contour which is peripheral on a horizontal plane. In embodiments, this closed contour can be rectangular with rounded corners. Circular contours however are also possible if a corresponding capsule is to be manufactured.

The main body and/or the lid of the capsule can be manufactured by deep-drawing.

The main body and/or lid can be manufactured of polypropylene, or alternatively of another plastic, in particular of a bio-plastic.

Apart from a method, the present invention also relates to a device for carrying out the method, wherein the device includes means for carrying out the method, thus in particular the separating tool with the blade which has the characteristics which are described in the present text. The device can moreover include a filling device and/or a welding device. Other features of the applied tools or aids which are described in this text are also optional features of the device.

The hardnesses which are compared in this text, inasmuch as are defined, are Rockwell hardnesses according to Scale C (HRC testing method). Supplementarily or alternatively (also for materials whose Rockwell hardness is not sufficiently defined), all details made also apply to the absolute hardness according to Rosiwal which characterises the behaviour given a grinding. The Mohs hardness scale can also be applied; for example one can envisage the first region having a Mohs hardness of at least 5.

### BRIEF DESCRIPTION OF THE DRAWINGS

Embodiment examples of the invention are hereinafter described by way of drawings In the drawings, the same reference numerals denote equal or analogue elements. The drawings are not true to scale and show elements which partly correspond to one another in sizes which are different from figure to figure. There are shown in:

FIG. 1 a capsule which is manufacturable with the method according to the invention;

FIG. 2 a main body for a capsule according to FIG. 1;

FIG. 3 a first example of a lid;

FIG. 4 a second example of a lid, shown partly sectioned;

FIG. 5 a sectioned representation of a detail of the capsule with a main body and lid, during the welding procedure;

FIG. 6 a separating anvil;

FIG. 7 a sectioned representation of a detail of the capsule with a main body and lid, during the separating procedure;

FIG. 8 a blade of the separating anvil;

FIG. 9 a schematic illustration of the self-sharpening effect;

FIG. 10 an alternative blade of a separating anvil;

FIG. 11 a sectioned representation of an alternative capsule.

### DETAILED DESCRIPTION OF THE INVENTION

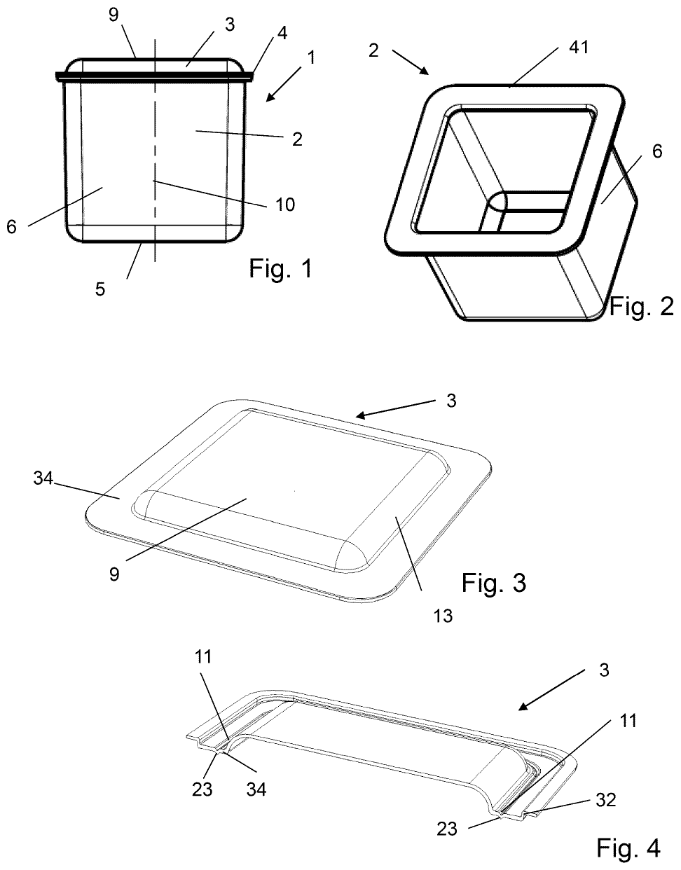

The capsule according to FIG. 1 essentially has the shape of a cube with rounded edges. The extension however slightly increases towards the side which lies at the top, to the extent that seen in a strict mathematical sense it has the shape of a truncated pyramid.

The capsule includes a main body (or cup) 2 and a lid 3 which is fastened thereto along a peripheral collar 4. The main body 2 forms a capsule base 5 and a peripheral side wall 6 which at its end which is at the outside with regard to axial directions (axis 10) and is at the top in FIG. 1, is terminated by the collar 4. The lid is arched to the outside by way of the lid surface 9 which is essential parallel to the capsule base 5 being set outwards in comparison to the peripheral collar 4.

FIG. 2 shows the base body 2 (cup) before the filling and before the closure. The main body collar 41 has an extension which is larger than that of the collar 4 of the finished capsule.

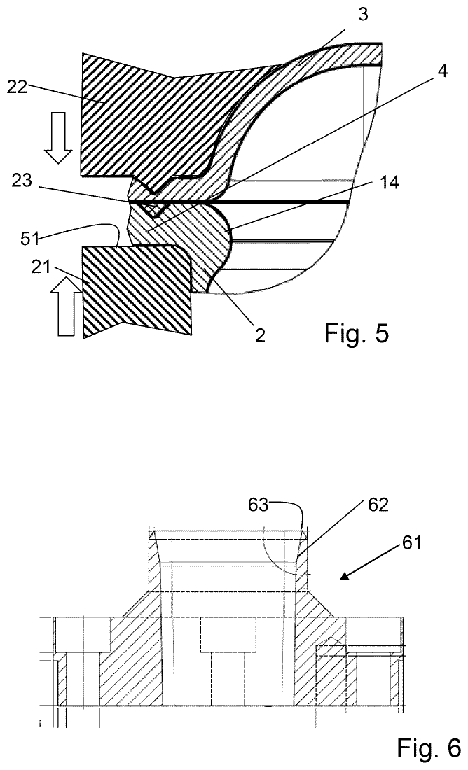

On manufacture of the capsule, the main body 2 is firstly filled with extraction material and the lid 3 is subsequently positioned. FIGS. 3 and 4 each show an embodiment example of a lid 3 which is manufactured by way of deep-drawing, wherein the embodiment according to FIG. 4 is represented in a section manner.

In the design according to FIG. 4, the lid includes an energy director 23. This is present in the region of the lid collar 34 and has the shape of a peripheral rib which is roughly V-shaped in cross section. A peripheral groove 11 accordingly forms on the rear side (after capsule manufacture on the outer side).

The lid collar and the capsule collar are over-dimensioned when compared to the end-product, i.e. they each form a lateral protrusion which is separated away on or after the fastening of the lid to the main body.

Furthermore, a set-back region is present on the protrusion in FIG. 4, so that a shoulder 32 is formed. The shoulder can serve as an aid on positioning relative to the main body.

Capsules, main bodies and lids of the type which are drawn in FIGS. 1-4 are also already known from the state of the art, for example from WO 2015/096990.

FIG. 5 schematically illustrates the step of welding the lid 3 to the main body 2, wherein it is not the complete collar 4 which is represented. On closing the capsule, the main body collar is supported from below by a first anvil 21. The first anvil 21 includes a cup-like shape which is matched to the main body 2, with an inner diameter which corresponds roughly to the outer diameter of the main body 2. At the upper side-quasi at the edge of the cup-it includes an essentially flat support surface 51. Due to this shape, the first anvil supports the main body whilst the cover 3 is being placed. A first sonotrode (welding sonotrode) 22 couples ultrasound energy from above into the lid collar, so that a welding takes place. The region which is represented with a cross hatching illustrates the initial position of the energy director 23; in reality the main body collar and the lid collar are also welded to one another next to this region after the closure.

Furthermore, an optional thickening 14 can be seen in FIG. 5 in the transition between the peripheral side wall and the main body collar 41. Such a thickening serves for the additional stiffening.

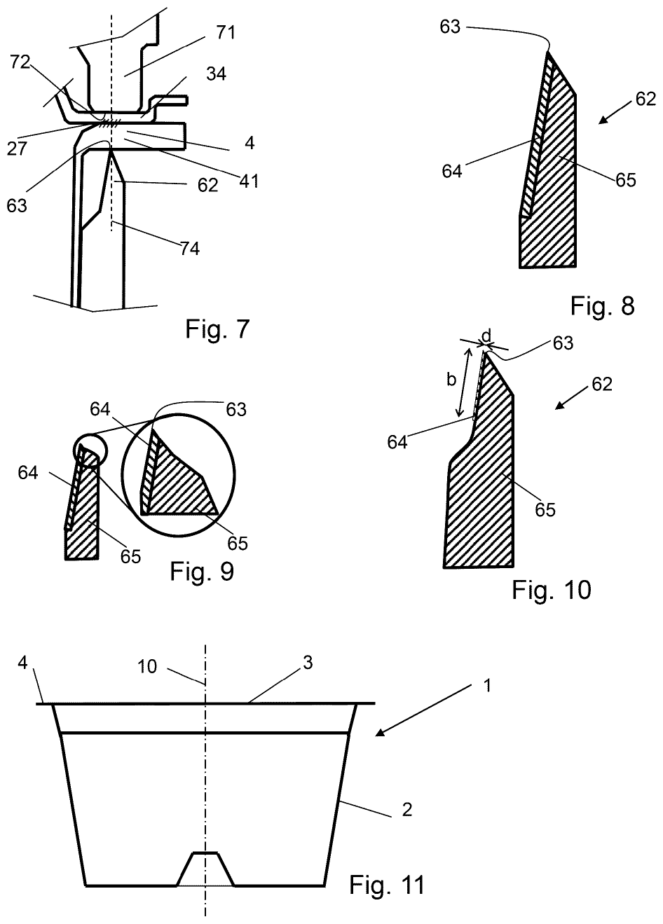

In a next step, the protrusion of the collar 4, which is formed from the main body collar 41 and the lid collar 34, which is welded thereto is separated away. For this purpose, the capsule is placed in a second anvil 61, which is represented in section in FIG. 6 and which similarly to the first anvil 61 has a cup-like shape, which is matched to the main body 2, with dimensions which are matched to this. In contrast to the first anvil, the upper edge forms no support surface, but a blade 62 with a cutting edge 63. As is illustrated in FIG. 7, an oscillating second sonotrode (separating sonotrode) 71 presses the collar 4 (with main body collar 41 and lid collar 34 which are connected to one another by way of welding 27) against the resting blade 62 until the collar is severed at the horizontal position of the cutting edge (dashed separating line 74). The downwardly directed coupling-out surface 72 of the sonotrode is herein extensive at least at the horizontal position 74 (position in the plane perpendicular to the axis 10; the axis is directed vertically during the method) and perpendicular to the axis, thus parallel to the lid collar 34 on which it lies.

This horizontal position 74 herein corresponds to a horizontal position of the welding 27, i.e. the blade penetrates the welding 27 and therefore the region of the collar 4 which is welded, during the separating procedure. The ultrasound herein has a dual effect: firstly, the ultrasound simplifies the separating procedure by way of mechanically simplifying the penetration of the blade into the material of the main body and subsequently that of the lid, and also by way of it effecting a local heating and therefore softening of the material. Secondly, on account of this local heating and softening, the ultrasound also effects a sealing of the welding 27 to the side.

Even if this ultrasound-induced separating procedure spares the peripheral blade 62 in comparison to a punching procedure, it has however been found that the blade 62 is burdened despite this. In order to prevent the peripheral blade-which has a relatively complicated shape-from having to be exchanged too often, the present invention suggests designing it in a multi-layered manner, with layers which have different hardnesses. An example is represented in FIG. 8. The blade 62 includes a blade body 65 of a first material, the blade body forming the second region. A coating 64 of a second, harder material is deposited on the blade body 65 at one side. The coating 64 forms the first region.

In the shown example, the blade body 65 consists of a hard metal, for example of steel, for example of a HSS with 65 HRC (Rockwell hardness; Scale C). The coating 64, which also forms the cutting edge 63, in the represented example is a ceramic coating for example tungsten carbide with 71 HRC. Alternative materials are hard metals based on tungsten carbide, for example a tungsten carbide cobalt hard metal or a tungsten carbide hard metal based on Ti, Ta, or Nb matrix or hard metals not based on tungsten carbide, for example so-called cermets.

The deposition of a coating of the drawn type can be effected for example in the form of a liquid ceramic coating varnish or by way of spraying.

The effect of the construction with the two regions is illustrated in FIG. 9. If material of the blade 62 is worn away at the cutting edge 63, then on account of the lower hardness an even greater material removal is effected in the second region 65. For this reason, the blade at the cutting edge is never thicker than the thickness of the coating-a self-sharpening effect.

The hardness of the sonotrode—at least in the region of the coupling-out surface 72—for example by way of a suitable coating—can be greater than the hardness of the first region 64, i.e. the sonotrode is even harder than the blade in the region of the cutting edge.

FIG. 10 shows an alternative blade 60, concerning which the first region 64 is designed as a thin coating of the second region 65 merely in the frontmost region towards the cutting edge 63. The thickness d of the first region in particular can be less than 30 μm. The width b (extension along the blade plane away from the cutting edge 63) can be for example relatively low, for example 0.5 mm-15 mm or 1-10 mm. In particular, one can succeed in relatively little material being sufficient for the formation of the first region, by way of a low width b of for example less than 5 mm, in particular less than 3 mm.

The present invention in particular is suitable for the manufacture of capsules of the shape which is drawn in FIG. 1, since on the one hand these have a relatively small-dimensioned capsule collar 4 after the procedure of the separating-away and on the other hand render necessary a relatively complexly shaped separating tool. However, the method is also suitable for the manufacture of capsules in more conventional capsule shapes, for example the shape which is shown in FIG. 11 and concerning which the main body 2 and at least at the end of the manufacturing procedure also the capsule lid 3 are designed in an essentially rotationally symmetrical manner about the axis (circularly symmetrical, i.e., symmetrical with respect to the rotation about an arbitrary angle).

1. A method for manufacturing a portion capsule that is filled with an extraction material, for the creation of a brewed product, comprising the steps of:
providing a main body of plastic, with a base region, with a peripheral side wall and with a peripheral main body collar which connects to the peripheral side wall;
providing a lid, with a lid collar, of a plastic;
filling the main body with an extraction material;
fastening the lid collar to the main body collar, whereby a capsule collar arises; and
separating-away an outer portion of the capsule collar;
wherein the separating-away of the outer portion is effected amid the use of a separating tool with a blade having a cutting edge, said blade being peripheral along the capsule collar, wherein the blade comprises a first region of a first material as well as a second region of a second material, wherein the first region extends up to the cutting edge and wherein the first material is harder than the second material.

2. The method according to claim 1, wherein the separating tool is designed as a separating anvil which comprises the blade and supports the capsule collar during the separating-away, wherein a vibrating separating sonotrode presses the capsule collar against the blade during the separating-away.

3. The method according to claim 2, wherein the separating sonotrode comprises a plane coupling-out surface.

4. The method according to claim 2, wherein the separating sonotrode comprises a coupling-out surface which is pressed against the capsule collar during the separating-away, wherein the method is carried out such that the separating sonotrode at no time completely contacts the blade.

5. The method according to claim 1, wherein the first region is formed by a one-sided coating of the second region.

6. The method according to claim 1, wherein the step of fastening the lid collar to the main body collar is effected by way of ultrasound welding.

7. The method according to claim 6, wherein a welding anvil and a welding sonotrode are used for the ultrasound welding, wherein the welding anvil supports the main body collar during the fastening, wherein the welding anvil is at rest during the fastening, and wherein during the fastening the welding sonotrode vibrates and presses the lid collar against the main body collar which is supported by the welding anvil.

8. The method according to claim 7, wherein the welding anvil has a plane support surface and wherein the welding sonotrode comprises a peripheral energy director or vice versa the welding anvil comprises a peripheral energy director and the welding sonotrode an extensive coupling-out surface.

9. A device for carrying out the method according to claim 1, comprising a fastening device for fastening the lid collar to the main body collar as well as a separating tool with a peripheral blade with a cutting edge, wherein the blade comprises a first region of a first material as well as a second region of a second material, wherein the first region forms the cutting edge and wherein the first material is harder than the second material.

10. The device according to claim 9, further comprising a filling device for filling the main body with the extraction material.

11. The device according to claim 9, wherein the fastening device is an ultrasound welding device.
